(19) United States
(12) Patent Application Publication
(10) Pub. No.: US 2011/0223517 A1
(43) Pub. Date: Sep. 15, 2011

(54) ASYMMETRIC ACIDIFICATION OF A MEMBRANE-ELECTRODE ASSEMBLY

(75) Inventors: Nengyou Jia, Hillsboro, OR (US); Jason M. Tang, Hillsboro, OR (US); Yang Song, Portland, OR (US)

(73) Assignee: CLEAREDGE POWER, INC., Hillsboro, OR (US)

(21) Appl. No.: 13/076,102

(22) Filed: Mar. 30, 2011

(51) Int. Cl. H01M 8/10; H01M 8/00

(52) U.S. Cl. 429/480; 429/535; 429/483

(57) ABSTRACT

In one embodiment, a method of making an MEA for a fuel cell comprises arranging a cathodic structure on a first surface of a PEM, and arranging an anodic structure on a second surface of the PEM, opposite the first surface, the anodic structure containing more PA per unit volume than the cathodic structure. The method further comprises pressing the cathodic and anodic structures to the PEM to form the MEA.

### TECHNICAL FIELD

This application relates to the field of PEM fuel cells, and more particularly, to avoidance of cathode flooding for improved performance in PEM fuel cells.

### BACKGROUND

In some fuel cells, a polymer-electrolyte membrane (PEM) is disposed between an anode, where fuel is electrochemically oxidized, and a cathode, where oxygen is electrochemically reduced. The PEM enables ions evolved at the anode to travel to the cathode, resulting in a charge-balanced redox reaction between the fuel and the oxygen. Besides maintaining suitable ionic conductance, the PEM should be impervious to the fuel and the oxygen, to prevent unwanted mixing, and it should be dimensionally stable over the operating-temperature range of the fuel cell. In typical usage, a catalytic and/or reactant-retentive structure may be bonded to each side of the membrane—i.e., an anodic structure bonded to the anode side and a cathodic structure bonded to the cathode side. Such structures, together with the PEM in between, comprise the so-called membrane-electrode assembly (MEA) of the fuel cell.

One type of PEM, attractive for its extended operating-temperature range, is the PBI-PA membrane. This membrane comprises a polybenzimidazole (PBI) film in which a significant quantity of phosphoric acid (H₃PO₄, PA) may be sorbed. It is believed that protons (formally H⁺) are conducted through this membrane via the sorbed PA as well as the PBI polymer electrolyte. An MEA based on such a membrane may be used in a hydrogen-air fuel cell at temperatures approaching 180° C.

However, PA loss from a PBI-PA membrane in an operating fuel cell may degrade fuel-cell performance by reducing the ionic conductance of the membrane. Over an extended period of time, such loss may also affect the dimensional stability of the membrane, leading to sealing problems and reactant cross-over. PA loss may therefore limit the usable lifetime of a PBI-PA membrane in a fuel cell. Accordingly, a PBI-PA membrane engineered for use in a fuel cell may be intentionally doped with excess PA. Each of the catalytic and/or reactant-retentive structures bonded to the membrane may also be doped with excess PA. In this manner, the MEA may store a sufficient amount of PA to offer an acceptably long usable lifetime despite gradual PA loss.

### SUMMARY

One embodiment of this disclosure provides a method of making an MEA for a fuel cell. The method comprises arranging a cathodic structure on a first surface of a PEM, and arranging an anodic structure on a second surface of the PEM, opposite the first surface, the anodic structure containing more PA per unit volume than the cathodic structure. The method further comprises pressing the cathodic and anodic structures to the PEM to form the MEA.

Another embodiment provides an MEA as described above, wherein a cathodic bipolar plate is disposed in face-sharing contact with the cathodic structure of the MEA, and an anodic bipolar plate is disposed in face-sharing contact with the anodic structure of the MEA.

Another embodiment provides a method of assembling a fuel cell. This method comprises installing between two bipolar plates of the fuel cell an MEA as described above, and applying force to the bipolar plates to seal the bipolar plates to the MEA without first adding additional PA to the cathodic structure.

The summary above is provided to introduce a selected part of this disclosure in simplified form, not to identify key or essential features. The claimed subject matter, defined by the claims, is limited neither to the content of this summary nor to implementations that address problems or disadvantages noted herein.

### BRIEF DESCRIPTION OF THE DRAWINGS

FIG. 1 illustrates a method for making an asymmetrically acidified MEA for a fuel cell in accordance with an embodiment of this disclosure.

FIG. 2 is a cross-sectional view showing aspects of an asymmetrically acidified MEA in accordance with an embodiment of this disclosure.

FIG. 3 illustrates a method for assembling a fuel cell in accordance with an embodiment of this disclosure.

FIG. 4 is an exploded view showing aspects of a fuel cell in accordance with an embodiment of this disclosure.

FIG. 5 is a graph comparing evolving operating voltages of fuel cells after installation of differently acidified MEAS.

### DETAILED DESCRIPTION

Aspects of this disclosure will now be described by example and with reference to the illustrated embodiments listed above. Components, process steps, and other elements that may be substantially the same in one or more embodiments are identified coordinately and are described with minimal repetition. It will be noted, however, that elements identified coordinately may also differ to some degree. It will be further noted that the drawing figures included in this disclosure are schematic and generally not drawn to scale. Rather, the various drawing scales, aspect ratios, and numbers of components shown in the figures may be purposely distorted to make certain features or relationships easier to see.

As noted above, a PBI-PA membrane engineered for use in a fuel cell may be intentionally doped with excess PA. Each of the catalytic and/or reactant-retentive structures bonded to the membrane may also be doped with excess PA. In this manner, the MEA may store a sufficient amount of PA to offer an acceptably long usable lifetime despite gradual PA loss. However, the inventors herein have discovered a disadvantage in the approach noted above. In particular, excess PA present on the cathode side of the membrane may flood the reactant-retentive structure bonded to the membrane, restricting oxygen diffusion and occluding the catalytic sites where oxygen reduction takes place. Excess PA on the cathode side may also encourage dihydrogen phosphate (H₂PO₄⁻) to adsorb on the catalytic sites, causing contamination. These factors may significantly degrade the operating voltage of the fuel cell, which is normally limited by cathode kinetics.

To address these issues and to secure still other advantages, this disclosure describes an asymmetrically acidified MEA for a fuel cell, a method of making an asymmetrically acidified MEA, and a method of assembling a fuel cell using an asymmetrically acidified MEA.

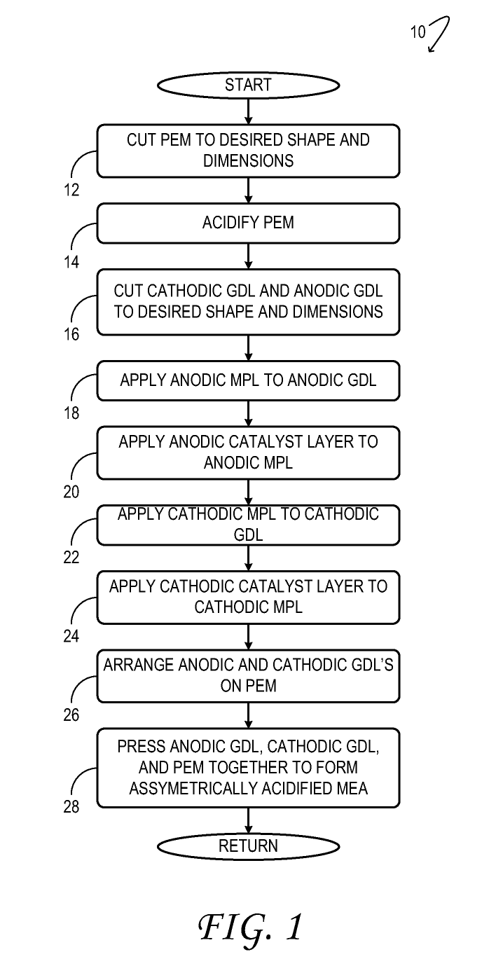

FIG. 1 illustrates an example method 10 for making an asymmetrically acidified MEA for a fuel cell. At 12 a PEM is cut from a dry, proton-conductive polymer electrolyte sheet to the desired shape and dimensions. In one embodiment, the sheet may comprise PBI of an appropriate thickness for use in an HT-PEM fuel cell; the thickness may be 50 microns in one example. In other embodiments, the sheet may comprise polybenzoxazine (PBOA), poly(2,5-benzimidazole) (ABPBI), or a derivatized PBI. In one embodiment, the chosen PEM may be especially thick and/or especially porous in order to increase the amount of PA sorbable therein.

At 14 the PEM is acidified by immersion in a bath containing aqueous PA at the desired temperature for certain period of time. In one example, the bath may contain 85% PA, although other concentrations may be used instead. After removal from the bath, the PEM may be wiped by dry paper towel to remove free PA and titrated to determine or estimate the PA concentration therein.

At 16 a cathodic gas-diffusion layer (GDL) and an anodic GDL are cut from a stock of carbon-fiber paper or carbon-fiber cloth to the desired shape and dimensions. In one embodiment, the carbon-fibers of the paper or cloth may be treated, before or after cutting, with a hydrophobizing agent, such as a polytetrafluoroethylene (PTFE) solution. At 18 an anodic microporous layer (MPL) is applied to the anodic GDL. The anodic MPL may be applied to the anodic GDL as a suspension of particles and dissolved solids in solvent vehicle. The suspension may be sprayed, painted, or screen-printed on the anodic GDL, for example. The particles in the suspension may include carbon—e.g., carbon black and/or graphite. In some embodiments, the suspension may also include silicon carbide particles to increase the amount of PA sorbable therein without sacrificing electrical conductivity.

The anodic MPL may also include PA. The PA may be initially present in the suspension of particles from which the anodic MPL is applied, or it may be added to the anodic MPL in a subsequent application.

At 20 an anodic catalyst layer is applied to the anodic MPL. The anodic catalyst layer may be applied to the anodic MPL as a suspension of particles and dissolved solids in solvent vehicle. It may comprise catalyzed carbon particles. Such particles may include any of the forms of carbon listed above and may support a suitable loading of a hydrogen-oxidation catalyst: finely divided platinum and/or ruthenium, as examples. The particles or vehicle may also include a hydrophobizing agent, such as PTFE. In one embodiment, the anodic catalyst layer may also include PA, whether delivered in the suspension of catalyzed carbon particles or in a subsequent application. In one embodiment, the combined amount of PA in the PEM and the anodic structure may be at least 15 milligrams per square centimeter (mg/cm²). Preferably, the combined amount of PA may be in the range of 20 to 28 mg/cm².

The inventors herein have observed that partial occlusion of catalytic sites of the anodic catalyst layer is less problematic than occlusion on the cathode side, as the operating voltage of the fuel cell is typically limited by cathode kinetics.

At 22 a cathodic MPL is applied to the cathodic GDL, and at 24, a cathodic catalyst layer is applied to the cathodic MPL. In one embodiment, the cathodic MPL and the cathodic catalyst layer may be substantially the same as the anodic MPL and anodic catalyst layer described above, except with regard to PA content. More specifically, the cathodic MPL and cathodic catalyst layer may contain less PA per unit volume that the corresponding anodic layers. For example, the suspension from which the anodic structure is applied may include more phosphoric acid per unit volume than the suspension from which the cathodic structure is applied. In one embodiment, the cathodic MPL and the cathodic catalyst layer may contain substantially no PA, while in other embodiments, these layers may include a relatively small amount of PA, in order to shorten the MEA conditioning time (vide infra).

In other embodiments, the cathodic MPL and/or cathodic catalyst layer may differ structurally from the corresponding anodic layer. In one embodiment, the anodic structure may be engineered to be especially thick and/or porous, relative to the cathodic structure, to increase the relative amount of PA sorbable therein. In a more particular embodiment, the thicker anodic layer may be the anodic MPL, not the anodic catalyst layer. In this manner, the expensive catalyst need not be dispersed in areas too far from the PEM to catalyze oxidation of fuel. In another embodiment, the anodic structure may include more PA-absorbing silicon carbide per unit volume than the cathodic structure.

In still other embodiments, the cathodic catalyst layer may support a different catalyst, a higher catalyst loading, etc. Further, the cathodic MPL and/or cathodic catalyst layer may engineered in view of a reduced need for PA storage relative to the corresponding anodic layers. For example, the MPL may be thinner, or include less silicon carbide per unit volume than the anodic MPL.

At 26 the anodic and cathodic GDLs, which support their respective MPLs and catalyst layers, are arranged in registry on opposite surfaces of the PEM. In this manner, a cathodic structure including a cathodic MPL and cathodic catalyst layer is arranged on a first surface of the PEM, and an anodic structure including an anodic MPL and anodic catalyst layer is arranged on a second surface of the PEM, opposite the first surface. As described above, the anodic structure in this embodiment may contain more PA per unit volume than the cathodic structure.

At 28 the anodic GDL that supports the anodic MPL and anodic catalyst layer, the cathodic GDL that supports the cathodic MPL and cathodic catalyst layer, and the PEM are pressed together to form an asymmetrically acidified MEA. In one particular embodiment, the assembly may be subject to heat pressing for 30 seconds at 160° C. at a pressure of 5 to 20 kilograms per square centimeter.

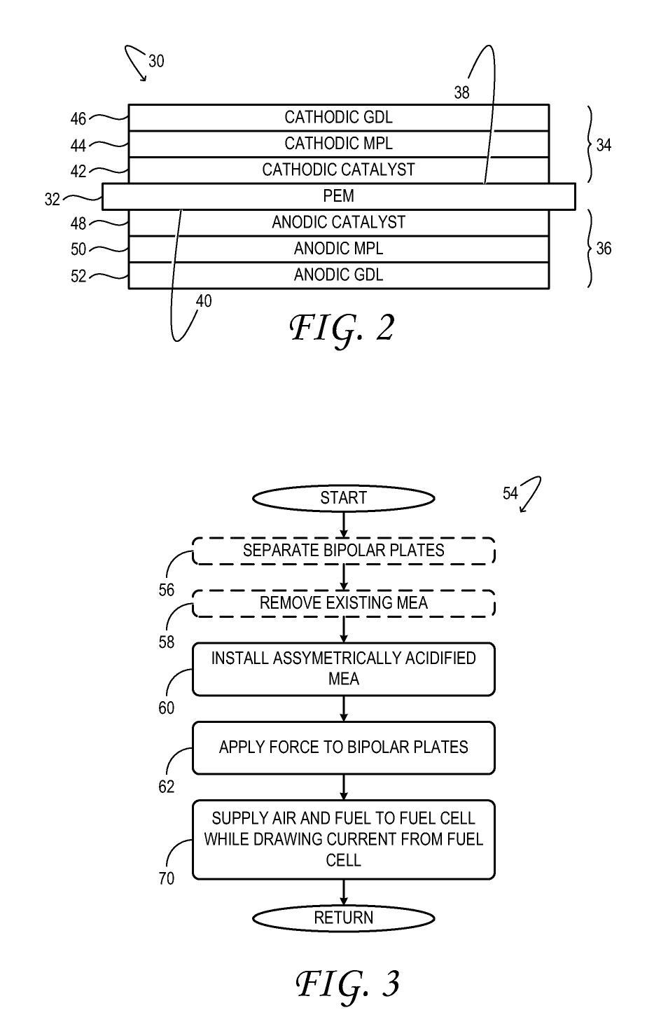

FIG. 2 is a cross-sectional view showing aspects of an asymmetrically acidified MEA 30 prepared as described above. The MEA includes PEM 32, cathodic structure 34, and anodic structure 36. The cathodic structure is arranged on first surface 38 of the PEM, and the anodic structure is arranged on second surface 40, opposite the first surface.

As shown in FIG. 2, cathodic structure 34 includes cathodic catalyst layer 42, arranged in direct contact with first surface 38, and cathodic MPL 44 arranged above the cathodic catalyst layer; these layers are applied to cathodic GDL 46. Similarly, anodic structure 36 includes anodic catalyst layer 48, arranged in direct contact with second surface 40, and anodic MPL 50 arranged below the anodic catalyst layer. The anodic catalyst layer and the anodic MPL are applied to anodic GDL 52. As noted above, the anodic structure may contain more PA per unit volume than the cathodic structure by virtue of the greater combined amount of PA stored in the anodic MPL and anodic catalyst layer, relative to the combined amount stored in the cathodic MPL and cathodic catalyst layer.

No aspect of FIG. 2 is intended to be limiting. In other embodiments, additional layers may be present in the asymmetrically acidified MEA. For example, an intervening anodic layer may be arranged between anodic MPL 50 and anodic GDL 52. The intervening layer may comprise carbon particles—e.g., XC-72 or another carbon black, graphite flakes from synthetic graphite and/or exfoliated natural graphite—in addition to silicon carbide and a carbon-supported platinum or platinum/ruthenium catalyst. The intervening layer may serve as a carbon-monoxide stripping layer and as a reservoir for additional, sorbed PA. Accordingly, method 10 may be extended to include application of the intervening layer from suitable suspensions of particles.

FIG. 3 illustrates an example method 54 for assembling a fuel cell. At 56 of this method, two opposing bipolar plates of a fuel cell are separated. At 58 an existing MEA found between the bipolar plates is removed. In embodiments in which the fuel cell is being assembled for the first time, one or both of the above actions may be omitted. At 60 an asymmetrically acidified MEA, such as MEA 30 described above, is installed between the bipolar plates. At 62 force is applied to the bipolar plates to seal the bipolar plates to the MEA. In this example, the fuel cell is sealed without first adding additional PA to the cathodic structure of the MEA, such that the MEA as installed retains a greater amount of PA per unit volume on the anode side than on the cathode side.

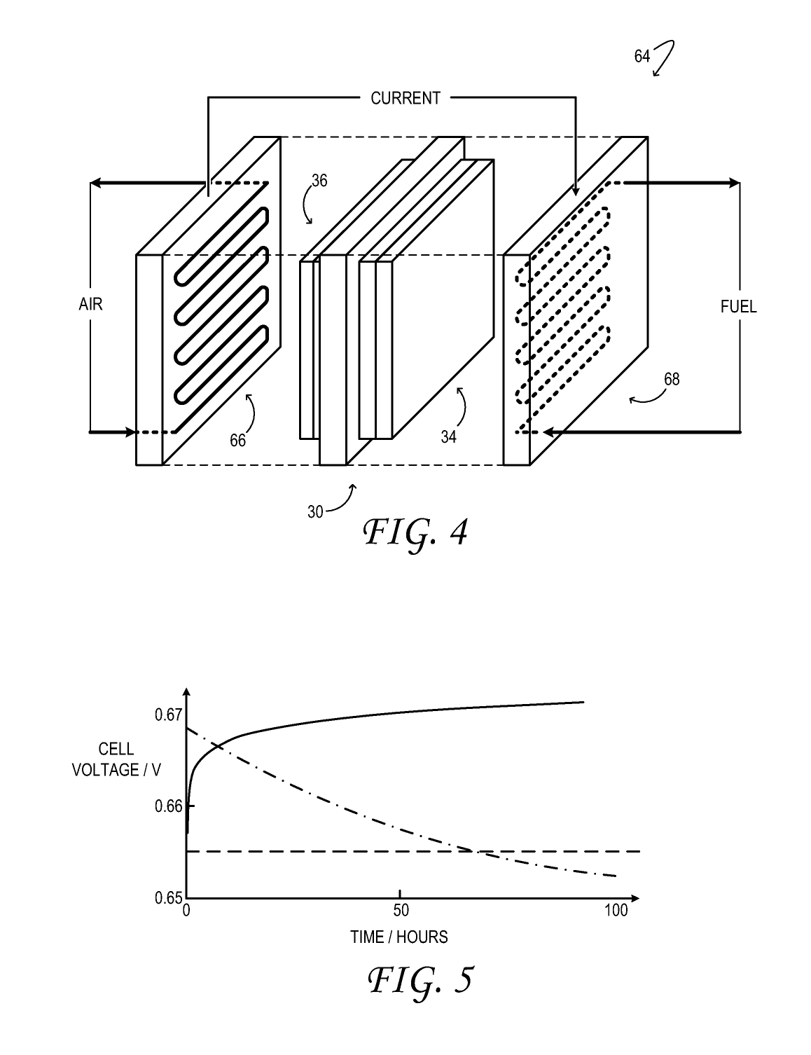

FIG. 4 is an exploded view showing aspects of an example fuel cell 64 assembled as described above. The illustrated fuel cell includes asymmetrically acidified MEA 30. The fuel cell also includes cathodic bipolar plate 66 disposed in face-sharing contact with cathodic structure 34 of the MEA, and anodic bipolar plate 68 disposed in face-sharing contact with anodic structure 36.

Returning now to FIG. 3, method 54 advances from 62 to 70, where air and fuel are supplied to the fuel cell while current is drawn from the fuel cell. This action, the inventors herein have observed, causes some PA initially retained in the anodic structure of the MEA to diffuse through the PEM until a suitable steady-state concentration builds up in the cathodic structure. In this manner, PA is delivered to the cathode in an amount suitable for desirably high ionic conductance and operating voltage. Further, there is reduced risk of cathodic MPL and catalyst flooding relative to a structure in which the excess PA is initially present in the anode and cathodic structures alike.

FIG. 5 is a graph comparing evolving operating voltages of identical fuel cells after installation of differently acidified MEAs. In each case, the fuel cell was initially held at 160° C. for ca. 20 minutes to accelerate PA balance in the MEA. The dashed line is for a commercially available MEA with no added PA; the solid line is for an analogous MEA in which 6.4 mg/cm² PA was added only to the anodic structure; and the dot-dashed line is for an analogous MEA in which 9.6 and 3.2 mg/cm² PA was added to both the anode and the cathodic structures, respectively.

As shown in the graph, the symmetrically acidified MEA very quickly achieves a maximum voltage, which decays thereafter, presumably due to PA flooding at the cathode. By contrast, the operating voltage of the asymmetrically acidified MEA builds more slowly, but remains high for an extended period of operation. In method 54, accordingly, the actions taken at 70 may be continued during a conditioning phase of the assembled fuel cell, wherein the operating voltage of the fuel cell increases to a desired—e.g., normal operating—level.

Naturally, some of the process steps described and/or illustrated herein may, in some embodiments, be omitted without departing from the scope of this disclosure. Likewise, the indicated sequence of the process steps may not always be required to achieve the intended results, but is provided for ease of illustration and description. One or more of the illustrated actions, functions, or operations may be performed repeatedly, depending on the particular strategy being used.

Finally, it will be understood that the articles, systems, and methods described herein are embodiments of this disclosure—non-limiting examples for which numerous variations and extensions are contemplated as well. Accordingly, this disclosure includes all novel and non-obvious combinations and sub-combinations of the articles, systems, and methods disclosed herein, as well as any and all equivalents thereof.

1. A method of making a membrane-electrode assembly for a fuel cell, the method comprising:
arranging a cathodic structure on a first surface of a polymer-electrolyte membrane;
arranging an anodic structure on a second surface of the polymer-electrolyte membrane, opposite the first surface, the anodic structure containing more phosphoric acid per unit volume than the cathodic structure;
pressing the cathodic and anodic structures to the polymer-electrolyte membrane to form the membrane-electrode assembly.

2. The method of claim 1, wherein the cathodic structure does not include phosphoric acid.

3. The method of claim 1, further comprising adding phosphoric acid to one or more components of the anodic structure.

4. The method of claim 1, further comprising adding phosphoric acid to the polymer-electrolyte membrane.

5. The method of claim 1, further comprising applying the cathodic structure to a cathodic gas-diffusion layer, and applying the anodic structure to an anodic gas-diffusion layer.

6. The method of claim 1, wherein applying the cathodic and anodic structures to their respective gas-diffusion layers comprises applying from a suspension of particles and dissolved solids in a solvent.

7. The method of claim 6, wherein the suspension from which the anodic structure is applied includes more phosphoric acid per unit volume than the suspension from which the cathodic structure is applied.

8. The method of claim 6, further comprising applying phosphoric acid to the anodic structure from a solution different than the suspension from which the anodic structure is applied.

9. A fuel cell comprising:
a membrane-electrode assembly including a polymer-electrolyte membrane having a cathodic structure arranged on a first surface and an anodic structure arranged on a second surface opposite the first surface, the anodic structure containing more phosphoric acid per unit volume than the cathodic structure;
a cathodic bipolar plate disposed in face-sharing contact with the cathodic structure;
an anodic bipolar plate disposed in face-sharing contact with the anodic structure.

10. The fuel cell of claim 9, wherein the polymer-electrolyte membrane comprises a polybenzimidazole.

11. The fuel cell of claim 9, wherein the cathodic structure includes a cathodic catalyst layer arranged in direct contact with the first surface and a cathodic microporous layer arranged over the cathodic catalyst layer, opposite the first surface, and wherein the anodic structure includes an anodic catalyst layer arranged in direct contact with the second surface and an anodic microporous layer arranged below the anodic catalyst layer, opposite the second surface.

12. The fuel cell of claim 11, wherein the cathodic structure further includes a cathodic gas-diffusion layer arranged over the cathodic microporous layer, and wherein the anodic structure includes an anodic gas-diffusion layer arranged below the anodic microporous layer.

13. The fuel cell of claim 12, wherein the anodic microporous layer is thicker than the cathodic microporous layer, but the anodic catalyst layer is not thicker than the cathodic catalyst layer.

14. The fuel cell of claim 9, wherein the anodic structure is thicker than the cathodic structure.

15. The fuel cell of claim 9, wherein the anodic structure includes more silicon carbide per unit volume than the cathodic structure.

16. The fuel cell of claim 9, wherein the amount of phosphoric acid included in the polymer-electrolyte membrane and in the anodic structure exceeds fifteen milligrams per square centimeter of the membrane.

17. A method of assembling a fuel cell, comprising:
installing between two bipolar plates of the fuel cell a membrane-electrode assembly including a polymer-electrolyte membrane having a cathodic structure arranged on a first surface and an anodic structure arranged on a second surface opposite the first surface, the anodic structure containing more phosphoric acid per unit volume than the cathodic structure; and
applying force to the bipolar plates to seal the bipolar plates to the membrane-electrode assembly without first adding additional phosphoric acid to the cathodic structure.

18. The method of claim 17, further comprising supplying air and fuel to the fuel cell while drawing current from the fuel cell, thereby causing some phosphoric acid retained in the anodic structure to diffuse to the cathodic structure.

19. The method of claim 18, wherein the air and fuel are supplied to the fuel cell and the current is drawn from the fuel cell during a conditioning phase wherein an operating voltage of the fuel cell increases.

20. The method of claim 18, wherein supplying air and fuel to the fuel cell comprises supplying fuel enriched in phosphoric acid vapor.
